(19) United States
(12) Patent Application Publication
(10) Pub. No.: US 2009/0057417 A1
(43) Pub. Date: Mar. 5, 2009

(54) IC CARD

(75) Inventors: Minoru SHINOHARA, Tokyo (JP); Takeshi Miura, Tokyo (JP); Kanji Mizuno, Tokyo (JP); Shigemasa Shiota, Tokyo (JP); Masayuki Suzuki, Tokyo (JP); Hirotaka Nishizawa, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/198,759

(22) Filed: Aug. 26, 2008

(30) Foreign Application Priority Data
Aug. 29, 2007 (JP) 2007-221971

(51) Int. Cl. G06K 19/067

(52) U.S. Cl. 235/492

(57) ABSTRACT

The present invention realizes a card on which a secure IC chip (a first semiconductor chip) that operates on both of a high power source voltage and a low power source voltage, and a nonvolatile semiconductor storage chip that operates on the lower power source voltage are mounted. Means for operating the card without exerting an adverse influence of the nonvolatile semiconductor storage chip when the high power source voltage is supplied is realized. A card has a voltage supply interrupting unit which is coupled to a power source terminal to which a first power source voltage and a second power source voltage higher than the first power source voltage are supplied, and a grounding terminal to which a grounding voltage is supplied. The voltage supply interrupting unit, when the first power source voltage is supplied, supplies voltage to a nonvolatile semiconductor storage chip and, when the second power source voltage is supplied, stops supplying the voltage to the nonvolatile semiconductor storage chip.

### CROSS-REFERENCE TO RELATED APPLICATIONS

The disclosure of Japanese Patent Application No. 2007-221971 filed on Aug. 29, 2007 including the specification, drawings and abstract is incorporated herein by reference in its entirety.

### BACKGROUND OF THE INVENTION

The present invention relates to a semiconductor device technology and, more particularly, in a semiconductor device (IC card) on which a plurality of semiconductor chips are mounted, relates to a technique for supplying a power source voltage supplied from the outside of a semiconductor device to any of the semiconductor chips.

In recent years, a multi-function card is realized by mounting a plurality of semiconductor chips obtained by providing a memory card with a security function while maintaining a memory card function, providing an IC card with an SIM (Subscriber Identity Module) function while maintaining an IC card function, or the like.

Paying attention to power source voltage, for example, Japanese Unexamined Patent Application Publication No. 2005-84935 (patent document 1) discloses a technique of mounting a nonvolatile semiconductor storage chip and a security controller chip on a memory card and applying the same operation voltage to the semiconductor chips.

International Publication WO01/084490 (patent document 2) discloses a technique of mounting a chip of a memory card unit and a chip of an SIM unit on an IC card and applying the same operation voltage to the semiconductor chips.

According to the examinations of the inventors of the present invention, it is necessary to consider the power source voltage supplied to an IC card on which a plurality of semiconductor chips are mounted and which has a plurality of card functions.

For example, the inventors herein have found the following problem.

An SIM card having an MMC (Multi Media Card (registered trademark)) function is used by being inserted in an IC card reader.

An IC card reader uses 3V or 5V as a power source voltage supplied to an IC card.

Consequently, the SIM card having the MMC function has to be adapted to both of the power source voltages.

A secure IC as an IC which is mounted on the SIM card having the MMC function and has the security function can operate on any of the power source voltages of 3V and 5V.

In contrast, an IC of the memory card function (hereinbelow, called a memory card unit) having a nonvolatile semiconductor storage device with the MMC function mounted on an SIM card can operate on the power source voltage of 3V. However, it is not permitted to apply the power source voltage of 5V to the IC from the viewpoint of reliability even though the IC can operate.

“3V” denotes a power source voltage in the range of, for example, 2.5V to 3.5V. “5V” denotes a power source voltage in the range of, for example, 4.5V to 5.5V.

As described above, in a card on which a plurality of semiconductor chips are mounted and which has a plurality of card functions, it is necessary not to apply a predetermined voltage or higher to a part of the semiconductor chips.

As another challenge, in the examinations of the inventors herein on the SIM card having the MMC function, the current that flows in the card in the standby mode is about 100 μA or higher and is expected to increase in future. The inventors herein have found that it is desirable to suppress the standby current.

As described above, in a card having a plurality of card functions, the standby current in the card as a whole has to be suppressed. However, a concrete technique has not been considered yet.

The above and other objects and novel features of the present invention will become apparent from the description of the specification and the appended drawings.

A plurality of inventions will be disclosed in the application. Outline of an embodiment will be briefly described as follows.

A semiconductor device as an embodiment includes: a power source terminal to which a first power source voltage and a second power source voltage higher than the first power source voltage are supplied; a grounding terminal to which a grounding voltage is supplied; a first power source line coupled to the power source terminal; a logic semiconductor chip which is coupled to the first power source line and the grounding terminal, operates on any of the first power source voltage and the second power source voltage, and performs a logic process on input data; a power supply interrupting semiconductor chip which is coupled to the first power source line and the grounding terminal, when the first power source voltage is supplied, outputs the voltage to a second power source line and, when the second power source voltage is supplied, stops supplying the voltage to the second power source line; a nonvolatile semiconductor storage chip which is coupled to the second power source line and the grounding terminal and operates on supply of the voltage; and a controller chip which is coupled to the second power source line and the grounding terminal, has a first terminal to which a signal is input and, on reception of the input signal, inputs/outputs data to/from the nonvolatile semiconductor storage chip.

Effects obtained by the embodiment in the plurality of inventions disclosed in the application will be representatively briefly described as follows.

By having the power supply interrupting semiconductor chip, the second power source voltage higher than the first power source voltage can be prevented from being supplied to the nonvolatile semiconductor storage chip.

### BRIEF DESCRIPTION OF THE DRAWINGS

FIG. 1 is an internal configuration diagram of an IC card as a semiconductor device of a first embodiment.

FIG. 2 is a diagram showing an electrode surface of the card of the embodiment.

FIG. 3 is an internal configuration diagram of an IC card as a semiconductor device of a second embodiment.

FIG. 4 is an internal configuration diagram of an IC card as a modification of the semiconductor device of the second embodiment.

FIG. 5 is an internal configuration diagram of an IC card as another modification of the semiconductor device of the second embodiment.

FIG. 6 is an internal configuration diagram of an IC card as a semiconductor device of a third embodiment.

FIG. 7 is an operation flowchart when a voltage supply interrupting unit is provided in a secure IC chip.

FIG. 8 is an internal configuration diagram of an IC card as a semiconductor device of a fourth embodiment.

FIG. 9 is an operation flowchart when the voltage supply interrupting unit is provided in a memory card.

FIG. 10 is an internal configuration diagram of an IC card as a semiconductor device of a fifth embodiment.

FIG. 11 is a layout drawing of semiconductor chips in an IC card as a semiconductor device of a sixth embodiment.

FIG. 12 is a cross section of a wiring board.

FIG. 13 is a layout drawing of a controller chip in the case where pads are arranged along both sides of a nonvolatile semiconductor storage chip.

FIG. 14 is a layout drawing of semiconductor chips when the voltage supply interrupting unit is arranged on the secure IC.

FIG. 15 is a layout drawing of semiconductor chips when the voltage supply interrupting unit is arranged along the second long side of a nonvolatile semiconductor storage chip.

FIG. 16 is a current mirror circuit diagram.

### DETAILED DESCRIPTION OF THE PREFERRED EMBODIMENTS

In the following description of embodiments, as necessary, the present invention is divided in a plurality of sections or embodiments. Unless otherwise specified, the sections or embodiments are related to one another and are (partly) modification, the details, addition, or the like of one another. In the following embodiments, when the number of elements (including a numerical value, a quantity, a range, and so on) is mentioned, except for the case where it is specified or the invention is clearly limited to a specific number in theory, the invention is not limited to the specific number. A number larger or smaller than the specific number may be employed. Obviously, in the following embodiments, the elements (including steps) are not always essential unless otherwise specified or considered to be obviously essential in theory. Similarly, in the following embodiments, the shapes, positional relations, and the like of the elements include approximate or similar ones unless otherwise specified or considered to be obviously essential in theory. The numerical values and ranges are similar to the above. In all of the drawings for explaining the embodiments, the same reference numerals are designated to components having the same functions and repetitive description will not be given. The embodiments of the invention will be described in detail hereinbelow with reference to the drawings.

### First Embodiment

### Internal Configuration of Card

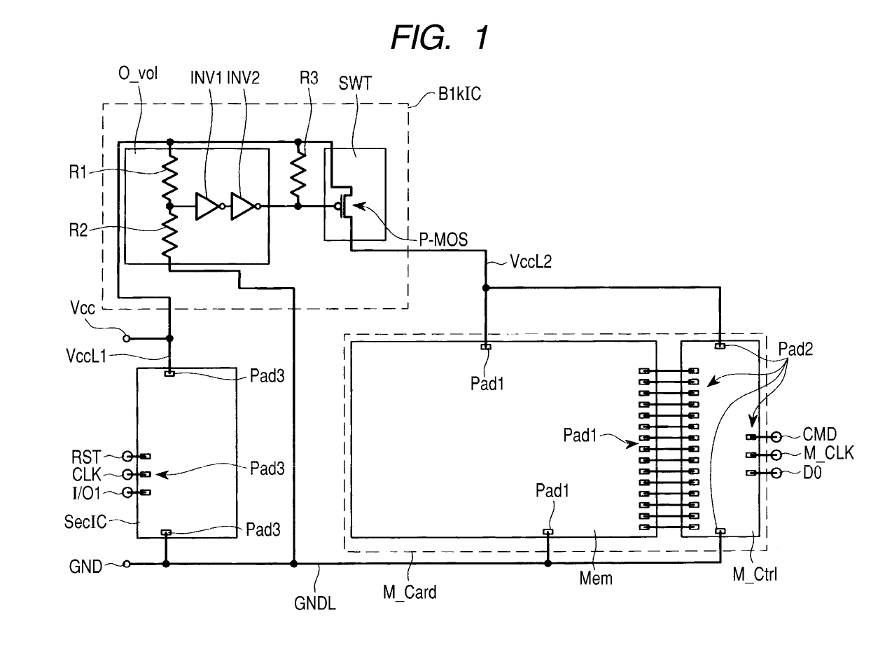

FIG. 1 is an internal configuration diagram of an IC card as a first semiconductor device of a first embodiment.

The semiconductor device of the first embodiment has, for example, the function of an IC card and the function of a memory card. Since the card has terminals in a manner similar to an IC card, it will be simply called an IC card below.

The IC card is comprised of semiconductor chips of three groups to be described below.

A semiconductor chip is not limited to a single chip and may be made of a plurality of chips but will be simply called a semiconductor chip.

As shown in FIG. 1, the IC card has a power source terminal Vcc to which a power source voltage is supplied from the outside of the card and a grounding terminal GND to which a grounding voltage is supplied from the outside of the card. Voltages are supplied into the card via the terminals.

In FIG. 1, an secure IC chip (a logic semiconductor chip, a first semiconductor chip, and a secure IC) SecIC is coupled to a first power source line VccL1 coupled to the power source terminal Vcc and a grounding line GNDL coupled to the grounding terminal GND.

The secure IC chip SecIC shown in the example is a kind of a logic semiconductor chip for performing a logic process on input data. Concretely, the security IC chip SecIC has a security function of taking measures against unauthorized reading and use of information of the user written in the IC card.

In FIG. 1, a voltage supply interrupting unit (a power supply interrupting semiconductor chip, a third semiconductor chip, a power supply interrupting circuit, and a voltage supply interrupting circuit) BlkIC is coupled to the first power source line VccL1, the grounding line GNDL, and a second power source line (power source line) VccL2 for supplying voltage to a memory card which will be described later. The voltage supply interrupting unit BlkIC has a function of supplying a voltage to the second power source line VccL2 and interrupting supply of the voltage to the second power source line VccL2 in accordance with the value of the power source voltage supplied from the power source terminal Vcc.

In FIG. 1, a memory card (second semiconductor chip) M_Card as a third group is coupled to the second power source line VccL2 and the grounding line GNDL. The memory card M_Card enters an operable state when the voltage is supplied from the second power source line VccL2 and reads/writes data when a signal from the outside is received.

### Secure IC Chip SecIC

As shown in FIG. 1, the secure IC chip SecIC is coupled to a reset terminal (second terminal) RST, a first clock terminal (second terminal) CLK, and a first I/O (Input/Output) terminal (second terminal) I/O1.

To the reset terminal RST, a reset signal for setting the inside of the secure IC chip SecIC to the initial state is input.

To the first clock terminal CLK, a clock signal capable of controlling the timing of the secure IC chip SecIC is input from the outside of the secure IC chip SecIC.

To the first I/O terminal I/O1, data and a command to be supplied to the secure IC chip SecIC is input synchronously with a clock signal input to the first clock terminal CLK. A signal responding to the data or command is output from the first I/O terminal I/O1 synchronously with the clock signal input to the first clock terminal CLK.

The secure IC chip SecIC operates in power source voltages in a wide range.

Concretely, the secure IC chip SecIC operates on either the power source voltage of, for example, 2.5V to 3.5V as the first power source voltage from the power source terminal Vcc or the power source voltage of, for example, 4.5V to 5.5V as the second power source voltage higher than the first power source voltage.

The secure IC chip SecIC steps down a power source voltage given from the outside and uses the resultant low voltage as the first or second power source voltage in the chip.

For example, when the external power source voltage is 3V, 3V is internally stepped down to 1.5V, and 1.5V is used as the internal power source voltage.

For example, when the external power source voltage is 5V, 5V is internally stepped down to 1.5V, and 1.5V is used as the internal power source voltage.

As an internal step-down circuit realizing the above operations, a normally-used circuit may be used.

For example, a configuration having a p-channel transistor P1 provided between a line to which the external power source voltage is applied and a line to which the internal power source voltage is supplied and a current mirror circuit CM for controlling the gate electrode of the P-channel transistor P1 may be used. An internal step-down circuit VD determines a voltage value Vout which is output according to a reference voltage REF. Therefore, for example, in the case of outputting a high voltage, the value of the reference voltage REF is made high. In the case of outputting a low voltage, the value of the reference voltage REF is made low.

As an example of the internal step-down, both of the first and second power source voltages are stepped down. It is also possible to use the first power source voltage as a lower power source voltage as it is without performing internal step-down and internally step down the second power source voltage.

### Voltage Supply Interrupting Unit BlkIC

The internal configuration of the voltage supply interrupting unit BlkIC will now be described with reference to FIG. 1.

The voltage supply interrupting unit BlkIC has an overvoltage detecting circuit O_vol for detecting whether or not the power source voltage supplied from the power source terminal Vcc is equal to or higher than a predetermined voltage, and a switch circuit SWT for supplying the power source voltage from the first power source line VccL1 to the second power source line VccL2 or interrupting the supply in accordance with an output from the overvoltage detecting circuit O_vol.

The overvoltage detecting circuit O_vol and the switch circuit SWT may be provided in different semiconductor chips or in a single semiconductor chip.

The method of providing both of the circuits for one semiconductor chip is effective at least from the viewpoint of decreasing the number of semiconductor chips.

The overvoltage detecting circuit O_vol has two voltage dividing resistors R1 and R2 coupled in series between the first power source line VccL1 and the grounding line GNDL and first and second inverters INV1 and INV2 coupled to the first power source line VccL1 and the grounding line GNDL, respectively.

When the power source voltage becomes predetermined voltage or higher, the voltage divided by the two voltage dividing resistors R1 and R2 becomes a predetermined voltage or higher. A signal to instruct the switch circuit SWT to interrupt the power source voltage is generated by the first and second inverters INV1 and INV2 in the overvoltage detecting circuit O_vol and is output to the switch circuit SWT.

The switch circuit SWT has a P-channel MOS (Metal Oxide Semiconductor) transistor P-MOS. The switch circuit SWT is coupled to the first power source line VccL1, supplies voltage, and outputs voltage to the second power source line VccL2.

The gate electrode of the P-channel MOS transistor P-MOS receives the output signal from the overvoltage detecting circuit O_vol. According to the signal, the P-channel MOS transistor P-MOS supplies the power source voltage to the second power source line VccL2 or interrupts supply of the power source voltage.

It is assumed that when the voltage of the power source terminal Vcc is 2.5V to 3.5V, the power source voltage is supplied to the second power source line VccL2. When the voltage of the power source terminal Vcc is 4.5V or higher, supply of the power source voltage to the second power source line VccL2 is interrupted.

For example, the resistance ratio of the voltage dividing resistors R1 and R2 is set as 1:1, and a logical threshold value of the first inverter INV1 is set as 2.0V.

In the case where the power source voltage is less than 4.0V, the divided voltage is less than 2.0V. The inverter INV1 outputs a high-level signal. The inverter INV2 supplies a low-level signal to the gate electrode of the P-channel MOS transistor P-MOS, and the voltage is supplied to the second power source line VccL2.

In the case where the power source voltage exceeds 4.0V, the divided voltage exceeds 2.0V. The inverter INV1 outputs a low-level signal. The inverter INV2 supplies a high-level signal to the gate electrode of the P-channel MOS transistor P-MOS, and the voltage is interrupted.

Although the boundary voltage of the power source voltage interruption is set as 4.0V, it may be properly changed according to the reliability or the like of the semiconductor chips.

In FIG. 1, a resistor R3 is provided between an output of the overvoltage detecting circuit O_vol and the first power source line VccL1. In the case where an output of the overvoltage detecting circuit O_vol is not stable, by applying the power source voltage to the gate electrode of the P-channel MOS transistor P-MOS, the P-channel MOS transistor P-MOS is turned off so as not to erroneously apply the overvoltage to the second power source line VccL2.

Although the switch circuit SWT is provided between the first power source line VccL1 and the memory card M_Card, it may be provided between the memory card M_Card and the grounding line GNDL. In this case, for example, the switch circuit SWT can be realized by using an N-channel MOS transistor N-MOS and inputting an inversion signal of the second inverter INV2 to the gate. Memory Card M_Card

In FIG. 1, the memory card M_Card has a nonvolatile semiconductor storage chip (nonvolatile semiconductor storage device) Mem and a controller chip M_Ctrl for controlling the nonvolatile semiconductor storage chip Mem.

In the semiconductor device of the first embodiment, a flush memory is taken as an example of the nonvolatile semiconductor storage chip Mem. Alternatively, a nonvolatile semiconductor memory may be used. The controller chip M_Ctrl is coupled to a second clock terminal (first terminal) M_CLK to which a clock for controlling the operation timing of the memory card M_Card is input, a command terminal (first terminal) CMD to which a signal for controlling the memory card M_Card is input, and a data terminal (first terminal) D0 to/from which data is input/output.

When data is written to the memory card M_Card synchronously with the clock signal input from the second clock terminal M_CLK, data is input from the data terminal D0. When data is read from the memory card M_Card, data is output from the data terminal D0.

The controller chip M_Ctrl controls the nonvolatile semiconductor storage chip Mem in accordance with inputs from the second clock terminal M_CLK and the command terminal CMD.

Concretely, at the time of writing data to the nonvolatile semiconductor storage chip Mem, a write command signal that instructs writing is input to the command terminal CMD, and write data is input to the data terminal D0. During or after the data input, the write instruction signal and write data is transferred from the controller chip M_Ctrl to the nonvolatile semiconductor storage chip Mem, thereby writing the data to the nonvolatile semiconductor storage chip Mem.

At the time of reading data from the nonvolatile semiconductor storage chip Mem, a read command signal that instructs reading is input to the command terminal CMD. After that, read data is transferred from the nonvolatile semiconductor storage chip Mem to the controller chip M_Ctrl, and the read data is output from the controller chip M_Ctrl via the data terminal D0.

Next, operations on the power source voltage of the memory card M_Card will be described.

The nonvolatile semiconductor storage chip Mem and the controller chip M_Ctrl are coupled between the second power source line VccL2 and the grounding line GNDL.

Any of the nonvolatile semiconductor storage chip Mem and the controller chip M_Ctrl becomes operable when power source voltage of 2.5V to 3.5V is given as a first power source voltage from the power source terminal Vcc. However, in the case where the second power source voltage higher than the first power source voltage, for example, the power source voltage of 4.5V to 5.5V is applied, the chips enter a disabled state. The disabled state includes a state that even if a chip is operable, an operation with the second power source voltage is not assured from the viewpoint of reliability.

As described with respect to the voltage supply interrupting unit BlkIC, for example, when the power source voltage is less than 4.0V, the voltage supply interrupting unit BlkIC supplies the power source voltage applied to the power source terminal Vcc to the second power source line VccL2. When the power source voltage exceeds 4.0V, the voltage supply interrupting unit BlkIC interrupts supply of the power source voltage to the second power source line VccL2.

Consequently, the power source voltage of, for example, 4.5V to 5.5V is not applied to the nonvolatile semiconductor storage chip Mem and the controller chip M_Ctrl.

An example of the difference between the configuration of the power source circuit in the secure IC chip SecIC and that of the memory card M_Card is as follows.

For example, when the external power source voltage lies in the range of 2.5V to 5.5V, the secure IC chip SecIC internally steps down the voltage to 1.5V, thereby generating an internal power source voltage.

On the other hand, the nonvolatile semiconductor storage chip Mem and the controller chip M_Ctrl in the memory card M_Card internally step down the external power source voltage in the range of, for example, 2.5V to 3.5V to 1.5V, thereby generating an internal power source voltage.

Alternatively, the controller chip M_Ctrl does not perform the internal step-down and may use an external power source voltage of, for example, 2.5V to 3.5V.

In the range of, for example, 2.5V to 3.5V, the secure IC chip SecIC and the memory card M_Card may use the external power source voltage without performing the internal step-down.

Another internal step-down method may be employed. It is sufficient to employ a configuration of a power source circuit such that the secure IC chip SecIC can operate on a power source voltage higher than that for the memory card M_Card.

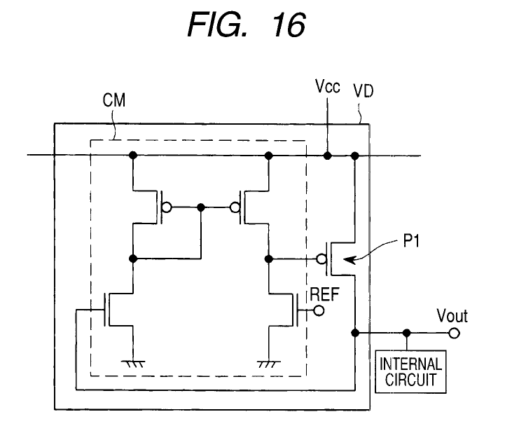

An internal step-down circuit VD as shown in FIG. 16 may be used.

### Electrodes on Card

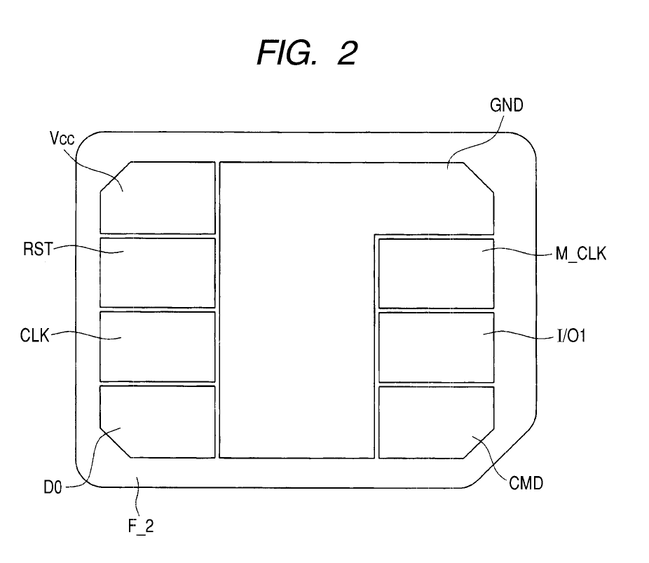

FIG. 2 shows an electrode surface of the card of the first embodiment. No electrodes are provided for the surface of the card opposite to the electrode surface of FIG. 2.

To electrodes corresponding to the terminals described with reference to FIG. 1, the same reference numerals are designated. As shown in FIG. 2, the card described in the first embodiment is provided with electrodes corresponding to the power source terminal Vcc, the grounding terminal GND, the reset terminal RST, the first and second clock terminals CLK and M_CLK, the command terminal CMD, the first I/O terminal I/O1, and the data terminal D0.

### Effects of First Embodiment

In the above, the IC card on which the secure IC chip SecIC capable of operating on the power source voltage in the wide range of 3V to 5V and the memory card M_Card capable of operating on about 3V as the power source voltage in the narrow range and lower than that of the secure IC chip SecIC are mounted has been described.

The case where the power source terminal Vcc and the grounding terminal GND shown in FIG. 2 are shared by the secure IC chip SecIC and the memory card M_Card and the power source voltage is supplied has been described.

In this case, the voltage supply interrupting unit BlkIC for controlling the power source voltage to be supplied to the memory card M_Card is formed on a chip different from those of the secure IC chip SecIC and the memory card M_Card.

With the configuration, it is unnecessary to provide the voltage supply interrupting unit BlkIC for interrupting supply of voltage when the voltage of 5V is supplied to both of the nonvolatile semiconductor storage chip Mem and the controller M_Ctrl configuring the memory card M_Card.

The case of providing the voltage supply interrupting unit BlkIC for both of the nonvolatile semiconductor storage chip Mem and the controller chip M_Ctrl different from the above-described configuration has the following inconvenience. One side of the rectangular shape of the voltage supply interrupting unit BlkIC is usually about 1.5 mm to 2.0 mm and the area is large. Consequently, when two voltage supply interrupting units BlkIC are provided, both of the area of the nonvolatile semiconductor storage chip Mem and that of the controller chip M_Ctrl increase, so that the area of the memory card M_Card increases.

In contrast, in the first embodiment, the voltage supply interrupting unit BlkIC is provided on the chip different from the chip of the memory card M_Card. Consequently, the area of the memory card M_Card can be reduced.

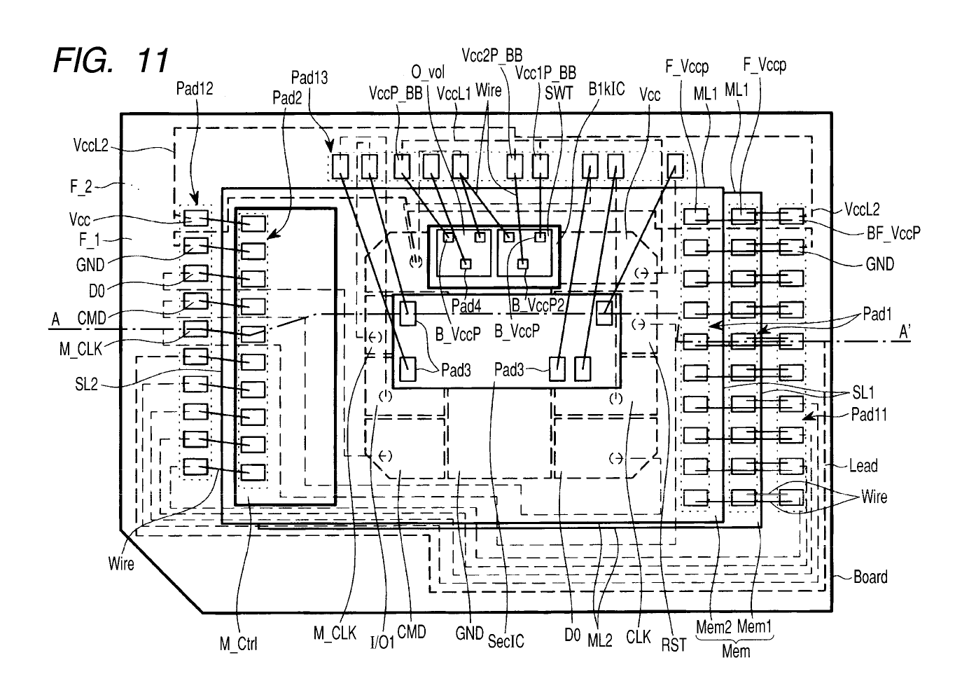

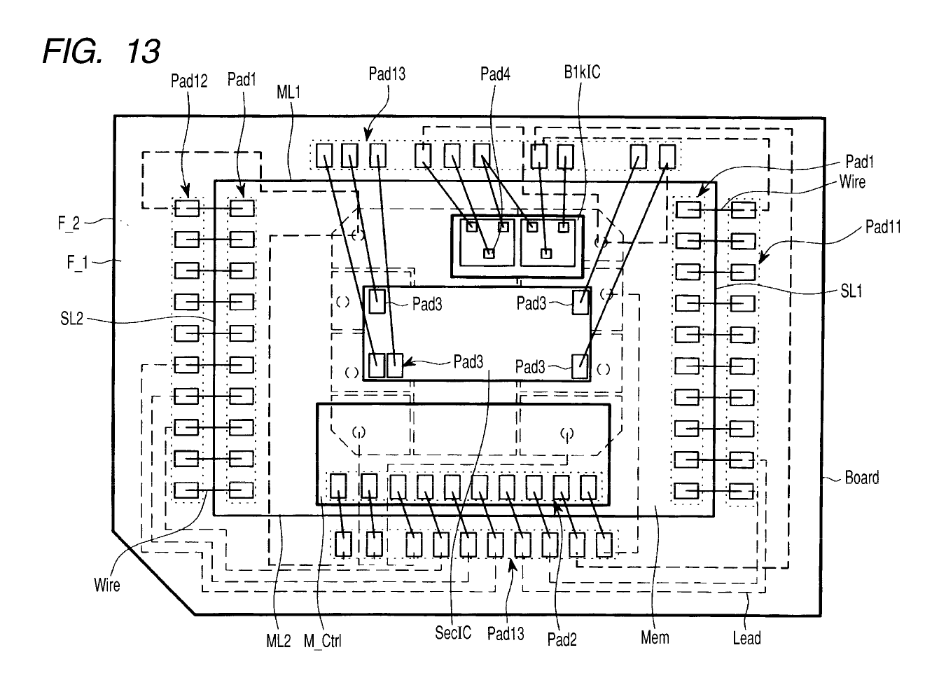

From another viewpoint, in the case where the semiconductor chips cannot be mounted on the same surface of the IC card, generally, a semiconductor chip of a smaller chip area is stacked on a semiconductor chip of a larger chip area. Stacking of the semiconductor chips will be more concretely described in detail later with reference to FIGS. 11, 13, and so on.

In this case, by reducing the area of the semiconductor chip which is the largest, allowance is created in the area in the plane of the IC card, and the area of the IC card itself can be reduced.

Particularly, the area of the nonvolatile semiconductor storage chip Mem is usually larger than that of any of the other chips such as the secure IC chip SecIC and the controller chip M_Ctrl.

Consequently, as a structure of mounting the semiconductor chips on the IC card, in the case of mounting the secure IC SecIC and the like on the nonvolatile semiconductor storage chip Mem, the area of the plane in the IC card is determined by the area of the nonvolatile semiconductor storage chip Mem. Therefore, when the area of the nonvolatile semiconductor storage chip Mem is not increased, it is effective to reduce the area of the plane in the IC card.

There is also a case that the nonvolatile semiconductor storage chip Mem has the internal step-down circuit VD, by sharing circuits between the voltage supply interrupting unit BlkIC and the internal step-down circuit VD, the voltage supply interrupting unit BlkIC may be provided for each of the nonvolatile semiconductor storage chip Mem and the controller chip M_Ctrl.

In this case as well, the circuits as a part of the voltage supply interrupting unit BlkIC cannot be shared with the internal step-down circuit VD. The circuits which cannot be shared have to be newly provided for each of the nonvolatile semiconductor storage chip Mem and the controller chip M_Ctrl.

According to the examinations of the inventors of the present invention, it is clarified that the chip of the first embodiment can be made smaller than that in the above case.

From another viewpoint, in the case where a plurality of semiconductor chips using different operation voltage ranges are amounted on an IC card, a semiconductor chip operating on a power source voltage in a wide range has therein the internal step-down circuit VD for stepping down the power source voltage.

On the other hand, on the outside of the semiconductor chip operating on the low power source voltage in the narrow range, the circuit for interrupting the power source when a high power source voltage is supplied is provided on another chip.

With the configuration, the semiconductor chip operating on the power source voltage in the wide range can adjust the value of an internal voltage for operation in the power source voltage in the wide range within the semiconductor chip itself.

On the other hand, for the semiconductor chip operating on the power source voltage in the narrow range, the circuit for interrupting the power source is provided on the outside of the chip. Consequently, when a high voltage is supplied, the power source voltage is not supplied. Only a power source voltage on which the semiconductor chip operating on the power source voltage in the narrow range can operate is received.

In contrast, when the circuit for interrupting high voltage is provided in the semiconductor chip operating on the power source voltage in the narrow range, at least the circuit part for interrupting the high voltage has to withstand the high voltage. Reliability at high voltage is required.

On the other hand, by providing the circuit for interrupting the power source on the outside of the chip, no high voltage is supplied. Consequently, reliability at high voltage is not required. Thus, the problem with respect to reliability at high power source voltage does hardly occur.

### Second Embodiment

### Layout of Capacitor

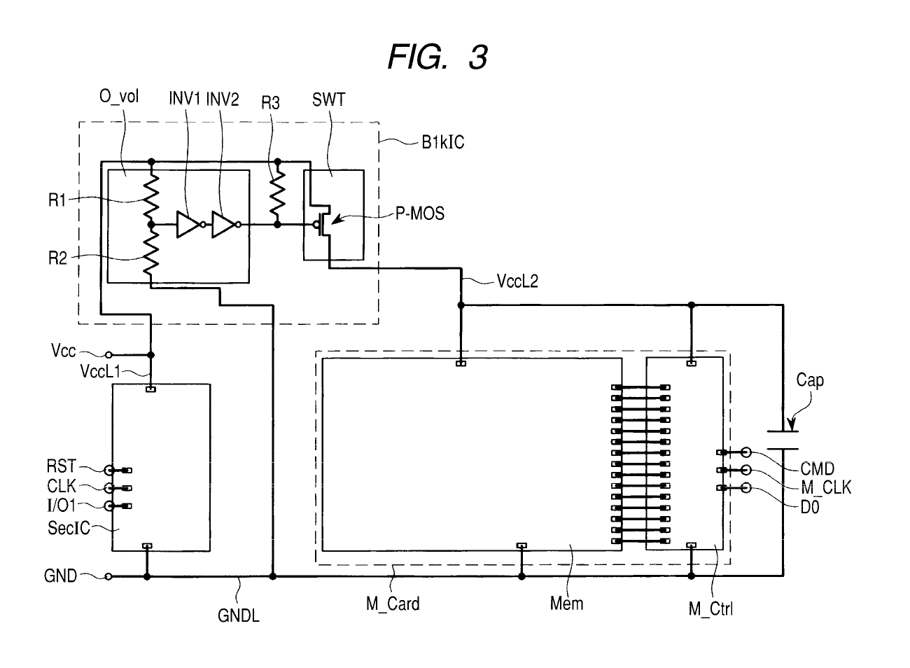

FIG. 3 is an internal configuration diagram of an IC card as a semiconductor device of a second embodiment. The difference of the second embodiment from the first embodiment described with reference to FIG. 1 is that a capacitor Cap is provided.

One of electrodes of the capacitor Cap is coupled to the second power source line VccL2, and the other electrode is coupled to the grounding line GNDL.

As shown in FIG. 3, the second power source line VccL2 extends from the voltage supply interrupting unit BlkIC to the memory card M_Card and further to the capacitor Cap.

That is, the length of the second power source line VccL2 from the voltage supply interrupting unit BlkIC to the capacitor Cap is longer than that of the second power source line VccL2 from the voltage supply interrupting unit BlkIC to the memory card M_Card.

The grounding line GNDL extends from the grounding terminal GND to the memory card M_Card and further to the capacitor Cap.

By providing the capacitor Cap, even if a temporary sharp drop occurs in the power source voltage to be supplied to the semiconductor device, a change in the voltage of the second power source line VccL2 can be suppressed.

By providing the capacitor Cap separately from the semiconductor chips, in consideration of the configuration of the whole card, the capacitor Cap can be freely disposed in the IC card.

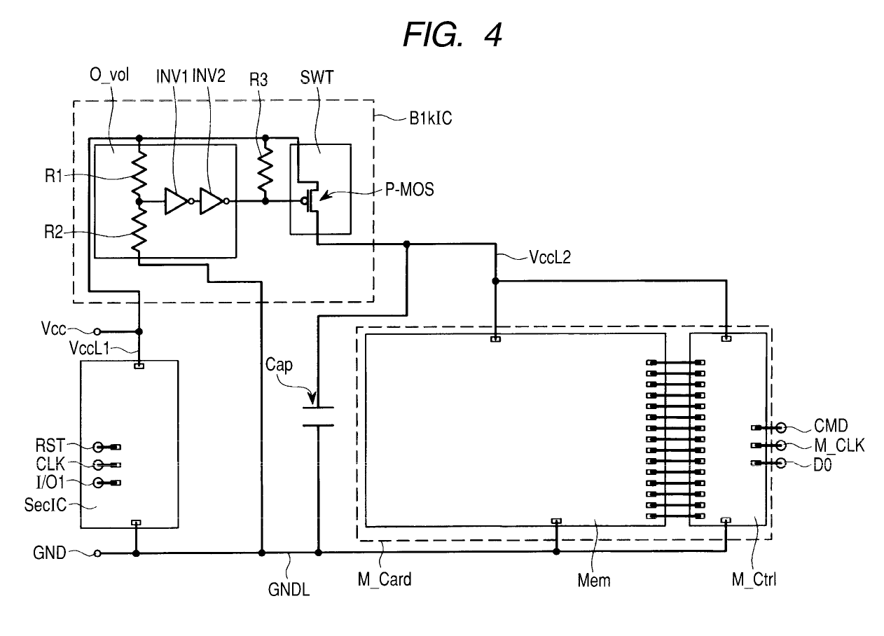

As an example of the placement of the capacitor Cap, the capacitor Cap is disposed in a position far from the memory card M_Card on the second power source line VccL2 when viewed from the voltage supply interrupting unit BlkIC as shown in FIG. 3. Alternatively, as shown in FIG. 4, the capacitor Cap may be disposed in a position closer to the memory card M_Card on the second power source line VccL2 when viewed from the voltage supply interrupting unit BlkIC.

In the case of FIG. 3, the capacitor Cap is disposed in a place farther than the memory card M_Card when viewed from the voltage supply interrupting unit BlkIC. Consequently, a voltage change in the second power source line (VccL2) can be made relatively gentle by a wire delay.

On the other hand, in the case of FIG. 4, the capacitor Cap is disposed in a place nearer than the memory card M_Card when viewed from the voltage supply interrupting unit BlkIC. Consequently, a voltage change can be absorbed relatively quickly as compared with the case of FIG. 3.

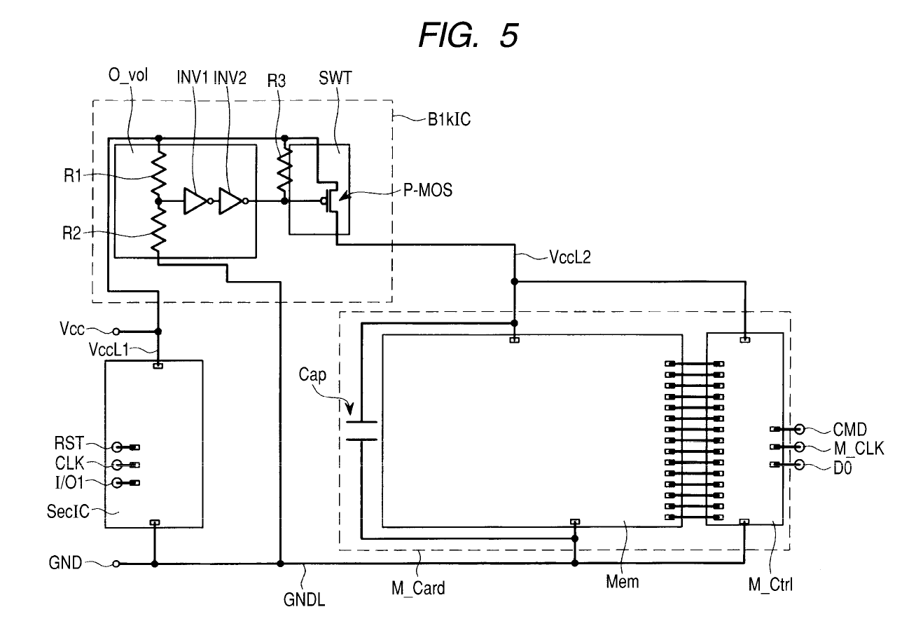

As shown in FIG. 5, the capacitor Cap may be disposed in the memory card M_Card.

Specifically, in the case of integrally molding the nonvolatile semiconductor storage chip Mem and the controller chip M_Ctrl and mounting them on a card, the capacitor Cap may be provided during the integration by molding.

### Effects of Second Embodiment

By disposing the capacitor Cap in a place farther than the memory card M_Card when viewed from the voltage supply interrupting unit BlkIC as shown in FIG. 3, a voltage change in the second power source line VccL2 can be made relatively gentle by a wire delay.

Therefore, even in the state where supply of a voltage from the outside is unstable, stable supply of voltage can be realized.

By disposing the capacitor Cap in a place closer than the memory card M_Card when viewed from the voltage supply interrupting unit BlkIC of the second power source line VccL2 as shown in FIG. 4, in the case where the power supply is stopped during the memory card M_Card operates, a sharp drop in the voltage can be suppressed.

With the configuration, even if the voltage from the outside drops for a moment for some reason during writing, the voltage change is absorbed by the capacitor Cap, so that the memory card M_Card can operate stably.

By disposing the capacitor Cap in the memory card M_Card as shown in FIG. 5 and integrating the capacitor Cap with the nonvolatile semiconductor storage chip Mem and the controller M_Ctrl by molding, moisture resistance of the capacitor Cap improves.

### Third Embodiment

Secure IC Chip SecIC having therein Voltage Supply Interrupting Unit BlkIC

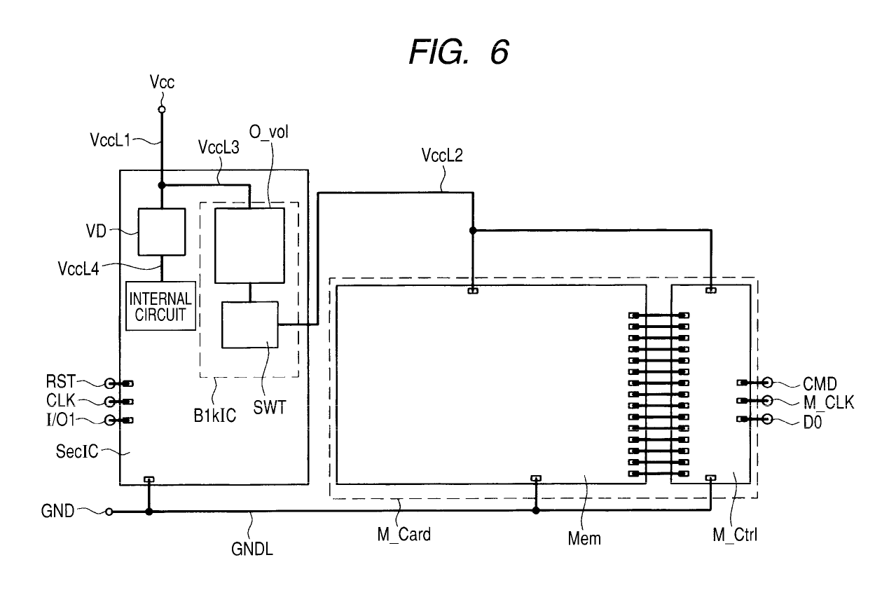

FIG. 6 is a configuration diagram of an IC card as a semiconductor device described in a third embodiment.

The third embodiment is different from the first embodiment described with reference to FIG. 1 with respect to the point that the voltage supply interrupting unit BlkIC is mounted on the secure IC chip SecIC and the IC card is comprised of the semiconductor chips of two groups; the secure IC chip SecIC, and the memory card M_Card.

In the case of supplying a power source voltage from the outside of the IC card, the power source terminal Vcc and the grounding terminal GND shown in FIG. 2 are used.

In FIG. 6, the secure IC chip SecIC is coupled to the first power source line VccL1 coupled to the power source terminal Vcc and the grounding line GNDL coupled to the grounding terminal GND.

Since the secure IC chip SecIC has therein the internal step-down circuit VD as shown in FIG. 16 in the first embodiment, it can operate on the power source voltage in the wide range. A voltage stepped down by the internal step-down circuit VD is supplied to internal circuits for internal operations of the secure IC chip SecIC such as operation of the secure process of the secure IC chip SecIC.

The voltage supply interrupting unit BlkIC mounted on the secure IC chip SecIC is coupled to a third power source line VccL3 as a wire in the secure IC chip SecIC coupled to the first power source line VccL1. When a voltage on which the memory card M_Card can operate, for example, 3V is supplied from the power source terminal Vcc, the voltage supply interrupting unit BlkIC coupled to the third power source line VccL3 supplies the voltage to the second power source line VccL2. When a voltage on which the memory card M_Card does not operate, for example, 5V is supplied, the voltage supply interrupting unit BlkIC interrupts the supply of the voltage.

The nonvolatile semiconductor storage chip Mem and the controller chip M_Ctrl are similar to those in the first embodiment described with reference to FIG. 1.

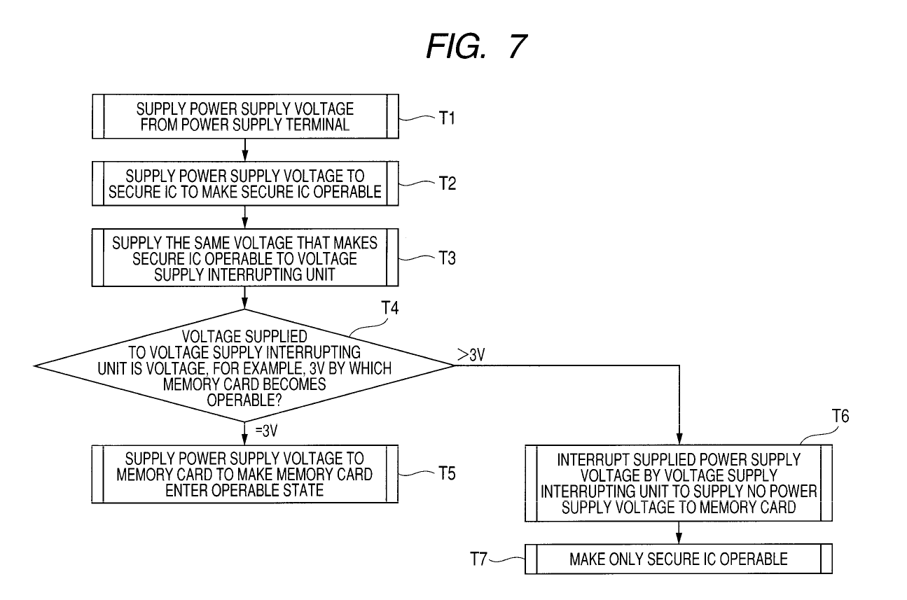

FIG. 7 is a flowchart showing the procedure of supplying the voltage from the secure IC chip SecIC having therein the voltage supply interrupting unit BlkIC shown in FIG. 6 to the memory card M_Card. The details will be described below.

First, the power source voltage is supplied from the power source terminal Vcc (step T1).

Second, the power source voltage is supplied to the secure IC chip SecIC, and the secure IC chip SecIC enters an operable state (step T2).

Third, the same voltage as the power source voltage supplied to the secure IC chip SecIC is supplied from the first power source line VccL1 to the voltage supply interrupting unit BlkIC (step T3).

Fourth, the voltage supply interrupting unit BlkIC determines whether the supplied voltage is a voltage on which the memory card M_Card can operate, for example, 3V or not (step T4).

In the case where the voltage, for example, 3V on which the memory card M_Card can operate is supplied, the power source voltage is applied to the memory card M_Card, and the memory card M_Card enters an operable state (step T5).

In the case where the voltage, for example, 5V on which the memory card M_Card does not operate is supplied, the voltage supply interrupting unit BlkIC interrupts the supplied power source voltage, so that the power source voltage is not supplied to the memory card M_Card (step T6). Only the secure IC chip SecIC enters an operable state (step T7).

### Effects of Third Embodiment

By mounting the voltage supply interrupting unit BlkIC in the secure IC chip SecIC, the IC card can be comprised of the semiconductor chips of two groups; the secure IC chip SecIC, and the memory card M_Card.

Since the voltage supply interrupting unit BlkIC is provided in the secure IC chip SecIC, the number of chips of the IC card can be decreased.

The voltage, for example, 5V on which the memory card M_Card does not operate is not supplied to the nonvolatile semiconductor storage chip Mem and the controller chip M_Ctrl.

Consequently, an erroneous operation of the memory card M_Card can be suppressed.

### Fourth Embodiment

### Memory Card M_Card Having Therein Voltage Supply Interrupting Unit BlkIC

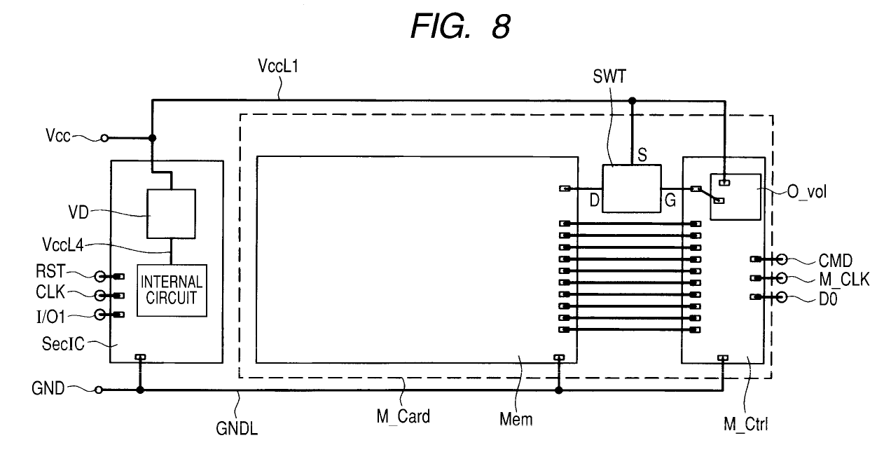

FIG. 8 is a configuration diagram of an IC card as a semiconductor device of a fourth embodiment.

The fourth embodiment is different from the first embodiment described by referring to FIG. 1 with respect to the point that the overvoltage detecting circuit O_vol in the voltage supply interrupting unit BlkIC is built in the controller chip M_Ctrl.

The overvoltage detecting circuit O_vol built in the controller chip M_Ctrl is coupled to the first power source line VccL1 for supplying the power source voltage to the controller chip M_Ctrl and the switch circuit SWT.

The switch circuit SWT is coupled to the first power source line VccL1 for supplying the power source voltage, the overvoltage detecting circuit O_vol built in the controller chip M_Ctrl, and the nonvolatile semiconductor storage chip Mem.

Each of the configuration of the overvoltage detecting circuit O_vol and the configuration of the switch circuit SWT is similar to that of the voltage supply interrupting unit BlkIC described with reference to FIG. 1 in the first embodiment.

The overvoltage detecting circuit O_vol is built in the controller chip M_Ctrl. The voltage is supplied from the first power source line VccL1 to the controller chip M_Ctrl. The voltage is supplied to the overvoltage supplying circuit O_vol.

For example, when the voltage supplied from the first voltage line VccL1 is the voltage of 3V on which the memory card M_Card can operate, the switch circuit SWT receives a signal output from the overvoltage detecting circuit O_vol in the controller chip M_Ctrl and is turned on. The voltage is supplied from the first power source line VccL1 to the nonvolatile semiconductor storage chip Mem.

For example, when the voltage supplied from the first voltage line VccL1 is the voltage of 5V on which the memory card M_Card does not operate, the switch circuit SWT receives an output signal from the overvoltage detecting circuit O_vol and is turned off. The supply of the voltage to the nonvolatile semiconductor storage chip Mem is stopped.

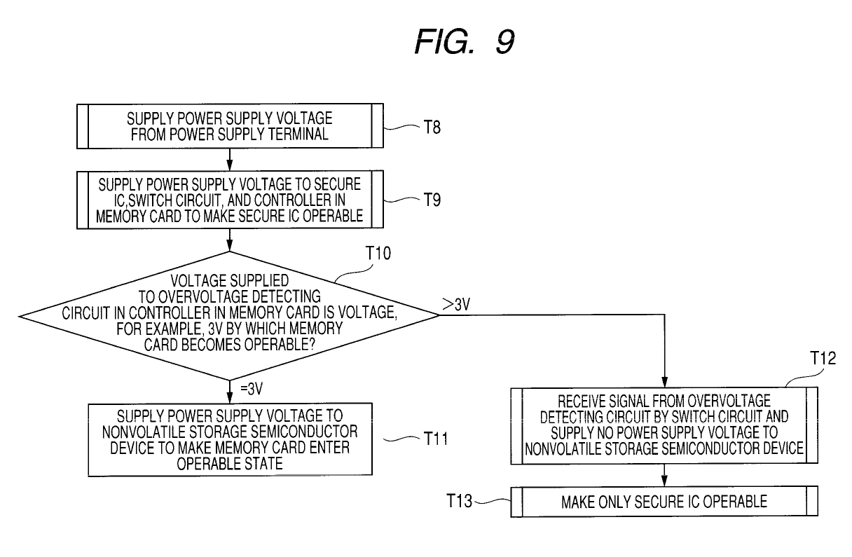

FIG. 9 is a flowchart showing the procedure of supply of voltage when the voltage supply interrupting unit BlkIC is built in the memory card M_Card. The details will be described below.

First, the power source voltage is supplied from the power source terminal Vcc (step T8).

Second, the power source voltage is supplied to the secure IC chip SecIC, the switch circuit SWT in the memory card M_Card, and the controller chip M_Ctrl in the memory card M_Card, and the secure IC chip SecIC enters an operable state (step T9).

Third, whether the voltage supplied to the overvoltage detecting circuit O_vol built in the controller chip M_Ctrl of the memory card M_Card is a voltage, for example, 3V on which the memory card M_Card can operate or not is determined (step T10).

In the case where the voltage, for example, 3V on which the memory card M_Card can operate is supplied, the power source voltage is supplied to the nonvolatile semiconductor storage chip Mem, and the memory card M_Card enters an operable state (step T11).

In the case where the voltage, for example, 5V on which the memory card M_Card does not operate is supplied, the switch circuit SWT interrupts the supplied power source voltage, so that the power source voltage is not supplied to the nonvolatile semiconductor storage chip Mem (step T12). Only the secure IC chip SecIC enters an operable state (step T13).

Although the overvoltage detecting circuit O_vol is built in the controller chip M_Ctrl and the switch circuit SWT is formed on another chip, the switch circuit SWT may be also built in the controller chip M_Ctrl.

With the configuration, the number of parts at the time of assembling the IC card can be decreased.

The switch circuit SWT may be built in the nonvolatile semiconductor storage chip Mem.

With this configuration as well, the number of parts at the time of assembling the IC card can be decreased.

By providing the switch circuit SWT on another chip not in the controller chip M_Ctrl, the power source current flowing in the nonvolatile semiconductor storage chip Mem can be prevented from flowing in the controller chip M_Ctrl.

Since the area of the switch circuit SWT is large, to reduce the area of the nonvolatile semiconductor storage chip Mem, it is more effective to provide the switch circuit SWT on another chip.

### Effects of Fourth Embodiment

By providing the overvoltage detecting circuit O_vol in the controller chip M_Ctrl as described above, as compared with the case where the overvoltage detecting circuit is provided on an independent chip, the number of parts at the time of assembling the IC card can be decreased.

### Fifth Embodiment

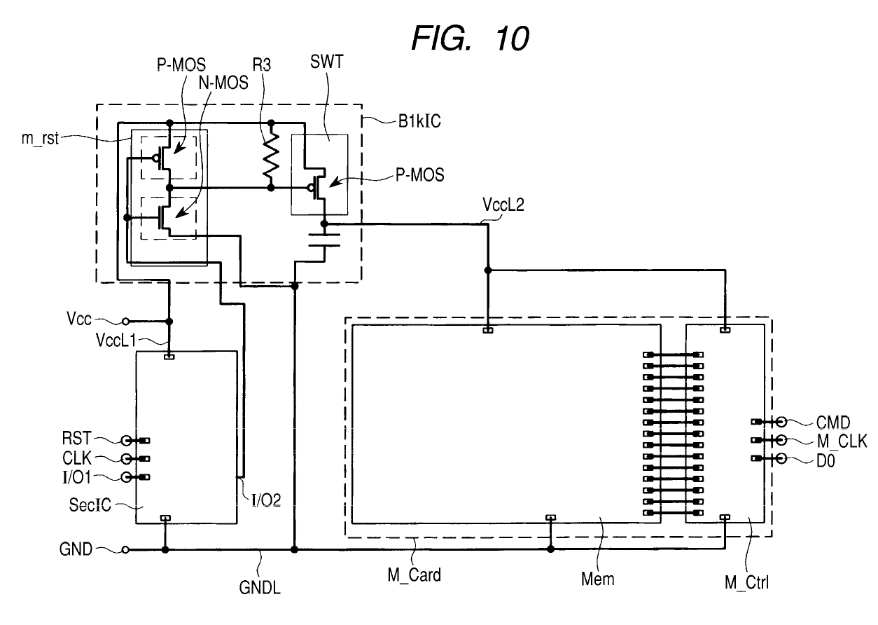

FIG. 10 is a configuration diagram of an IC card as a semiconductor device of a fifth embodiment.

The IC card has a manual reset circuit (power source voltage supply control circuit) m_rst having the function capable of switching between operation of supplying the power source voltage of the memory card M_Card and operation of stopping the supply of the power source voltage in accordance with an input signal from the outside of the IC card.

FIG. 10 shows an example where the voltage supply interrupting unit BlkIC has therein the manual reset circuit m_rst.

The manual reset circuit m_rst may be provided in the secure IC chip SecIC and the memory card M_Card.

As shown in FIG. 10, the voltage supply interrupting unit BlkIC has the manual reset circuit m_rst capable of switching between the operation of supplying the voltage and the operation of stopping the voltage supply in accordance with a signal from the outside received from the secure IC chip SecIC, and the switch circuit SWT for supplying the power source voltage from the first power source line VccL1 to the second power source line VccL2 or interrupting the supply in accordance with an output from the manual reset circuit m_rst.

Manual Reset Circuit m_rst

The manual reset circuit m_rst can stop supply of the power source voltage in accordance with an input signal from the outside of the IC card which is input to the secure IC chip SecIC and the like.

Any of the power source voltage on which the memory card M_Card can operate or the power source voltage on which the memory card M_Card cannot operate may be supplied.

To prevent a voltage higher than the specified power source voltage from being applied to the memory card M_Card, it is desirable to control the supply of the power source voltage in accordance with an input signal from the outside of the IC card only in the case where the power source voltage on which the memory card M_Card can operate is supplied.

In accordance with an input signal from the outside which is input to the secure IC chip SecIC or the like during stop of the supply of the power source voltage, the power source voltage can be supplied to the memory card M_Card.

As shown in FIG. 10, the manual reset circuit m_rst in this example has a P-channel MOS transistor P-MOS and an N-channel MOS transistor N-MOS.

The manual reset circuit m_rst is coupled to a terminal for outputting a signal generated in accordance with a control signal input from the external terminal of the secure IC chip SecIC. The terminal for outputting a signal to the manual reset circuit m_rst will be called a second I/O terminal I/O2.

The signal supplied from the outside of the IC card and controlling the manual reset circuit m_rst is input from the first I/O terminal I/O1 used for inputting data and a control signal in the secure IC chip SecIC.

The signal for controlling the manual reset circuit m_rst in the IC card according to a control signal supplied from the outside is output from the second I/O terminal I/O2.

When the power source voltage of, for example, 3V is supplied from the power source terminal Vcc and a power source voltage stop signal or a voltage supply signal is not input from the outside to the memory card M_Card, the power source voltage is supplied to the second power source line VccL2. For this purpose, the secure IC chip SecIC holds data in a circuit capable of holding data such as a latch circuit (not shown) provided for the secure IC chip SecIC to set an output signal of the second I/O terminal I/O2 at a high level.

When the power source voltage supply stop signal to the memory card M_Card is input from the outside to the first I/O terminal I/O1, a low-level signal is output from the second I/O terminal I/O2. According to the signal, the P-channel MOS transistor P-MOS is switched on and the P-channel MOS transistor P-MOS outputs a high-level signal to stop the supply of the power source voltage.

The latch circuit in the secure IC chip SecIC holds data so that the second I/O terminal I/O2 maintains a low-level state.

In the case where the power source voltage supply signal to the memory card M_Card is input from the outside in a state where the low-level signal is output from the second I/O terminal I/O2 to the manual reset circuit m_rst, an output signal from the second I/O terminal I/O2 changes from a low-level signal to a high-level signal. By the change, the N-channel MOS transistor N-MOS is turned on, the low-level signal is output from the N-channel MOS transistor N-MOS, and the power source voltage is supplied to the memory card M_Card.

The matters on consumption current examined by the inventors of the present invention will now be described.

A state where a signal input from the outside of the IC card to the controller chip M_Ctrl does not change for a predetermined period is usually called a standby state. In the standby state, consumption current of about 10 to 50 μA and consumption current from about 100 to 300 μA flow in the nonvolatile semiconductor storage chip Mem in the memory card M_Card and the controller chip M_Ctrl, respectively. The consumption current of the controller chip M_Ctrl is determined by the internal step-down circuit VD or the like for internally stepping down the external power source of 2.5V to 3.5V to 1.5V.

Conventionally, since the internal step-down circuit VD and the like in the memory card M_Card operates also when the memory card M_Card is in the standby state, the current of about 100 to 300 μA is consumed.

On the other hand, also in the secure IC chip SecIC, current of 100 to 400 μA flows in the standby state.

As illustrated in the fifth embodiment, by stopping supply of the power source voltage to the memory card M_Card in the standby state, the current consumed in the memory card M_Card can be suppressed.

The memory card is a nonvolatile semiconductor memory capable of holding data even when supply of the power source voltage stops. Consequently, even when supply of the power source voltage stops, there is no problem.

According to verification of the inventors of the present invention, by using the technique disclosed in the fifth embodiment, the consumption current of the IC card as a whole is suppressed to about the half in the standby state, so that it is effective.

It is particularly effective when the power source voltage is interrupted in the standby state in a chip having the internal step-down circuit VD.

The internal step-down circuit VD steps down the power source voltage supplied from the outside also in the standby state so that a high voltage is not applied to the inside of the chip, and current by the voltage flows.

Since current flows in circuits other than the internal step-down circuit VD in the standby mode, even in the case where the internal step-down circuit VD is not provided, there is an effect of reducing power consumption.

Although the example in which the manual reset circuit m_rst is controlled via the secure IC chip SecIC has been described above, other methods may be employed.

For example, it is also possible to couple the reset terminal RST, the first clock terminal CLK, and the first I/O terminal I/O1 of the secure IC chip SecIC to the voltage supply interrupting unit BlkIC (not shown) and control the manual reset circuit m_rst by an input signal of the first I/O terminal I/O1 in accordance with the timings and combination of the signals of the reset terminal RST and the first clock terminal CLK.

In this case, the signal for controlling the manual reset circuit m_rst does not pass through the secure IC chip SecIC.

Therefore, the output terminal of the control signal (in the fifth embodiment, the second I/O terminal I/O2) in the secure IC chip SecIC can be made unnecessary.

### Effects of Fifth Embodiment

The manual reset circuit m_rst can stop supply of the power source voltage in accordance with an input signal from the outside of the IC card.

During stop of the supply of the power source voltage, in accordance with an input signal from the outside of the IC card, the power source voltage can be supplied to the memory card M_Card.

The consumption current of the memory card M_Card can be suppressed by being controlled from the outside of the IC card.

### Sixth Embodiment

FIG. 11 is a layout drawing of semiconductor chips in an IC card as a semiconductor device of a sixth embodiment. FIG. 11 shows an example of mounting the components described by referring to FIG. 1 in the first embodiment on a card.

The same reference numerals are designated to the same components as those in the first embodiment and the corresponding drawings.

The IC card has, as individual semiconductor chips, the secure IC chip SecIC, the nonvolatile semiconductor storage chip Mem in the memory card M_Card, the controller chip M_Ctrl, and the voltage supply interrupting unit BlkIC. The semiconductor chips are disposed on a placement surface (first surface) F_1 of a wiring board “Board”.

Although the card electrodes shown in FIG. 2 are illustrated also in FIG. 11, the electrodes (external terminals) are provided on an electrode surface F_2 positioned on the side opposite in the thickness direction to the placement surface F_1 of the wiring board on which the semiconductor chips are mounted. Therefore, the card electrodes are not seen from the surface on which the semiconductor chips are mounted. However, they are shown in FIG. 11 for convenience in order to show the positional relations and coupling relations with the semiconductor chips. The card electrodes and wires (to be described later) coupled to the terminals of the card electrodes which are disposed on the electrode surface F_2 as the rear surface of the placement surface F_1 of the wiring board “Board” and are not seen from the placement surface F_1 are shown by broken lines in FIG. 11.

The nonvolatile semiconductor storage chip Mem has a rectangular shape. Generally, the area of the nonvolatile semiconductor storage chip Mem is larger than that of any of the other semiconductor chips mounted on the IC card. Consequently, the nonvolatile semiconductor storage chip Mem is disposed in a position closer to the placement surface F_1 than the other chips.

Specifically, when the wiring board “Board” is the lowest layer, the nonvolatile semiconductor storage chip Mem is mounted on the wiring board “Board”, and the other chips are mounted on the nonvolatile semiconductor storage chip Mem.

The nonvolatile semiconductor storage chip Mem can be also obtained by stacking a plurality of nonvolatile semiconductor storage chips Mem as shown in FIG. 11. In this case, two nonvolatile semiconductor storage chips are disposed. A second nonvolatile semiconductor storage chip Mem2 as an upper layer is disposed on a first nonvolatile semiconductor storage chip Mem1 as a lower layer so as to be slightly deviated from each other in a direction along the placement surface F_1 and the electrode surface F_2 of the wiring board “Board”.

The controller chip M_Ctrl has a square shape and its area is smaller than that of the nonvolatile semiconductor storage chip Mem. Consequently, the controller chip M_Ctrl can be disposed on the nonvolatile semiconductor storage chip Mem as shown in FIG. 11.

The controller chip M_Ctrl is disposed so that a short side of the second nonvolatile semiconductor storage chip Mem2 and a side of the controller chip M_Ctrl extend along each other in a position close to one of the short sides of the nonvolatile semiconductor storage chip Mem having the rectangular shape.

In this case, the controller chip M_Ctrl is disposed so that a short side of the nonvolatile semiconductor chip Mem2 and a long side of the controller chip M_Ctrl extend along each other.

The secure IC chip SecIC has a square shape and its area is smaller than that of the nonvolatile semiconductor storage chip Mem. Consequently, as shown in FIG. 11, the secure IC chip SecIC can be stacked on the second nonvolatile semiconductor storage chip Mem2.

The secure IC chip SecIC is disposed almost in the center of the nonvolatile semiconductor storage chip Mem2.

The voltage supply interrupting unit BlkIC has two chips of the overvoltage detecting circuit O_vol and the switch circuit SWT and has a square shape, and its area is smaller than that of the nonvolatile semiconductor storage chip Mem. Consequently, the voltage supply interrupting unit BlkIC can be mounted on the second nonvolatile semiconductor storage chip Mem2 as shown in FIG. 11.

The voltage supply interrupting unit BlkIC is disposed so as to be sandwiched by a long side (first long side) ML1 of the second nonvolatile semiconductor storage chip Mem2 having a rectangular shape and the secure IC chip SecIC.

### Pads of Semiconductor Chip

As shown in FIG. 11, the wiring board “Board” has a plurality of pads Pad11, Pad12, and Pad13 (hereinbelow, described as pads of wiring board) as electrodes formed by a metal film or the like made of aluminum or the like coupled to the wires of the wiring boards “Board”.

The pads Pad11 to Pad13 on the wiring board are disposed around the nonvolatile semiconductor storage chip Mem.

As shown in FIG. 11, the nonvolatile semiconductor storage chip Mem has a plurality of pads Pad1 (hereinbelow, described as pads of the nonvolatile semiconductor chip) as electrodes formed by a metal film or the like made of aluminum or the like coupled to circuits in the nonvolatile semiconductor storage chip Mem at one short side SL1 of the nonvolatile semiconductor storage chip Mem having a rectangular shape.

Although the example of disposing the pads Pad1 of the nonvolatile semiconductor storage chip along the short side SL1 is described, the pads Pad1 may be disposed along the long side ML1 or another long side (second long side) ML2 facing the long side ML1.

That is, it is sufficient to concentratedly dispose pads along one of the four sides of the rectangular-shaped nonvolatile semiconductor storage chip Mem.

The pads Pad1 of the nonvolatile semiconductor storage chip are coupled to the pads Pad11 of the wiring board disposed along pads Pad1 of the nonvolatile semiconductor storage chip via wires “Wire”.

The pads Pad1 of the two nonvolatile semiconductor storage chips Mem1 and Mem2 are disposed on the same short side SL1. The second nonvolatile semiconductor storage chip Mem2 as an upper layer is disposed by being deviated so that the pads Pad1 of the first nonvolatile semiconductor storage chip Mem1 as a lower layer are not covered with the second nonvolatile semiconductor storage chip Mem2.

By the placement of the pads Pad1 of the nonvolatile semiconductor storage chips on the same one side and the above-described deviation, a plurality of nonvolatile semiconductor storage chips Mem can be easily coupled to each other via the pads Pad11 of the wiring board and the wires “Wire”. That is, the coupling of the wires “Wire” for coupling the pads Pad11 of the wiring board and the pads Pad1 of the nonvolatile semiconductor storage chip can be made less complicated as compared with that in the case where pads are provided on a plurality of sides of the nonvolatile semiconductor storage chip Mem.

As shown in FIG. 11, the controller chip M_Ctrl is disposed on the side closer to the short side (first short side) SL2 opposite to the short side SL1 of the nonvolatile semiconductor storage chip Mem on which the pads Pad1 of the nonvolatile semiconductor storage chip are disposed.

A plurality of pads Pad2 coupled to circuits in the controller chip M_Ctrl (hereinbelow, described as pads of the controller) are disposed along the short side SL2 positioned opposite to the short side SL1 on which the pads Pad1 of the nonvolatile semiconductor storage chip are disposed in the nonvolatile semiconductor storage chip Mem.

The pads Pad2 of the controller are provided concentratedly on one of the long sides of the controller chip M_Ctrl. In the case where the controller chip M_Ctrl has a rectangular shape, it is easier to concentratedly provide the pads Pad2 of the controller on one side than the case where the shape is a square of the same area.

The pads Pad2 of the controller are coupled to the pads Pad12 of the wiring board disposed along the short side SL2 of the nonvolatile semiconductor storage chip Mem on the wiring board “Board” via the wires “Wire”.

By using one side, the pads can be coupled without making the coupling via the wires “Wire” complicated.

In the secure IC chip SecIC, as shown in FIG. 11, pads Pad3 coupled to circuits in the secure IC chip SecIC (hereinbelow, described as pads of the secure IC chip) are disposed in positions close to four corners of the secure IC chip SecIC.

In the voltage supply interrupting unit BlkIC, as shown in FIG. 11, pads Pad4 coupled to circuits in the voltage supply interrupting unit BlkIC (hereinbelow, described as pads of the voltage supply interrupting unit) are disposed.

The pads Pad3 of the secure IC chip and the pads Pad4 of the voltage supply interrupting unit are coupled to each other via the pads Pad13 of the wiring board disposed along the long side ML1 of the nonvolatile semiconductor storage chip Mem and the wires “Wire”.

As shown in FIG. 11, the length of the side facing the long side ML1 (similarly also the long side ML2) of the nonvolatile semiconductor storage chip Mem in the voltage supply interrupting unit BLKIC is shorter than that of the secure IC chip SecIC.

Consequently, by disposing the pads Pad3 of the secure IC chip in positions close to the four corners of the secure IC chip SecIC, sufficient intervals from the wires “Wire” coupled to the voltage supply interrupting unit BlkIC can be assured more than the case where the pads Pad3 of the secure IC chip are disposed in the center portion of the secure IC chip SecIC. It can be also designed so that the wires “Wire” coupled to the secure IC chip SecIC do not extend over the voltage supply interrupting unit BlkIC.

Among the pads Pad13 of the wiring board disposed along the one long side ML1 of the nonvolatile semiconductor storage chip Mem, the pads to be coupled to the pads Pad3 of the secure IC chip are disposed so as to sandwich the pads coupled to the pads Pad4 of the voltage supply interrupting unit.

With the configuration, the wiring configuration of the wires “Wire” coupled between the pads Pad3 of the secure IC chip and the pads Pad13 of the wiring board and between the pads Pad4 of the voltage supply interrupting unit and the pads Pad13 of the wiring board can be prevented from becoming complicated.

### Pads of Power Source and the Like

The pads Pad1 to Pad4 of the semiconductor chips are coupled to the pads Pad11 to Pad13 of the wiring board via the wires “Wire” as shown in FIG. 11.

It was described in the foregoing first embodiment using FIG. 1 as an equivalent circuit diagram that the power source voltage is supplied from an external terminal to the nonvolatile semiconductor storage chip Mem. FIG. 11 shows the wires for supplying the power source voltage from the external terminals to the nonvolatile semiconductor storage chip Mem.

As shown in FIG. 11, the power source terminal Vcc to which the power source voltage is supplied from the outside is coupled to the first power source line VccL1. The first power source line VccL1 is coupled to a pad VccP_BB coupled to the voltage supply interrupting unit BlkIC among the pads Pad13 of the wiring board.

The pad VccP_BB is coupled to, in the pads Pad4 of the voltage supply interrupting unit, particularly, a pad B_VccP for supplying the power source voltage to the voltage supply interrupting unit BlkIC and the wires “Wires”. The pad B_VccP2 for outputting the power source voltage to the second power source line VccL2 is on the voltage supply interrupting unit BlkIC and is coupled to a pad Vcc2P_BB of the wiring board coupled to the second power source line VccL2 via the wire “Wire”.

The second power source line VccL2 shown in FIG. 11 is provided in the wiring board “Board” and is coupled to a pad BF_VccP of the wiring board for supplying the power source voltage to the nonvolatile semiconductor storage chip Mem.

The pad BF_VccP o the wiring board is coupled to a pad F_VccP on the nonvolatile semiconductor storage chip for supplying the power source voltage to the nonvolatile semiconductor storage chip Mem via the wire.

The coupling of the wires and pads of the power source voltage system has been described as an example. As understood from FIG. 11, the grounding voltage system, the signal system, and the data system are also coupled via wires and pads.

The numbers of pads Pad1 and Pad2 of the nonvolatile semiconductor storage chip Mem and the controller chip M_Ctrl are not limited to those shown in FIG. 11.

### Wiring Board

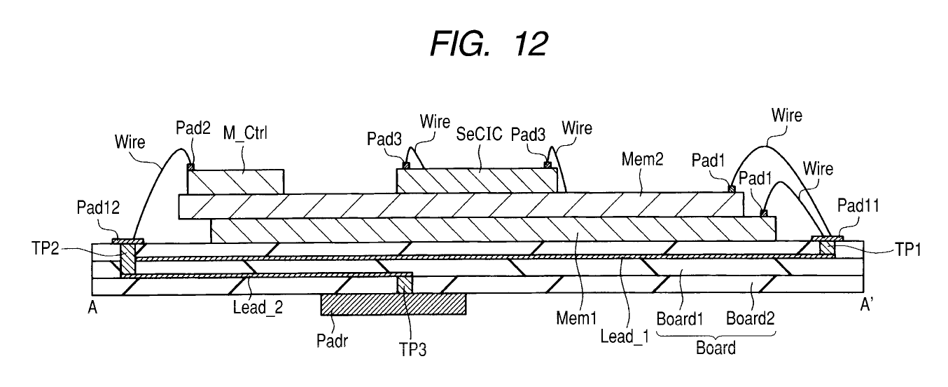

FIG. 12 is a cross section taken along line A-A′ in the layout drawing shown in FIG. 11.

The wiring board “Board” has the placement surface F_1 as the first surface on which a plurality of semiconductor chips are mounted and the electrode surface F_2 as the second surface which is the rear surface on the back of the placement surface F_1. The electrode surface F_2 has a rear-face pad Padr as an electrode for coupling to the outside as described by referring to FIG. 2 in the first embodiment. The wiring board “Board” has a plurality of wiring board layers (in the sixth embodiment, two wiring board layers Board1 and Board2) as shown in FIG. 12 and is formed by stacking the wiring board layers Board1 and Board2.

As shown in FIG. 12, the wiring board layer Board1 has a first lead wire Lead_1 for coupling the semiconductor chips via the pads Pad11 to Pad13 of the wiring board on the placement surface F_1. The first lead wire Lead_1 corresponds to the second power source line VccL2 or the like in FIG. 11.

The wiring board layer Board2 has the second lead wire Lead_2 for coupling the pads Pad11 to Pad13 of the wiring board provided for the placement surface F_1 (in FIG. 12, particularly, the pad Pad12 of the wiring board) and the rear-face pad Padr provided for the electrode surface F_2. The second lead wire Lead_2 corresponds to the first power source line VccL1 or the like in FIG. 11.

The first lead wire Lead_1 is coupled to the pads Pad11 to Pad13 and the like of the wiring boards (in FIG. 12, particularly, the pad Pad11 of the wiring board) via a buried electrode TP1.

Similarly, the second lead wire Lead_2 is coupled to the pads Pad11 to Pad13 and the like of the wiring boards (in FIG. 12, particularly, the pad Pad12 of the wiring board) via a buried electrode TP2, and is coupled to the rear-face pad Padr coupled to the outside via a buried electrode TP3.

As described above, by providing two lead wires, the problem that the wires cross each other can be eliminated, and the flexibility of the wires increases. Case Where Pads Pad1 of Nonvolatile Semiconductor Storage Chip are Disposed along Two Short Sides SL1 and SL2 FIG. 13 is a layout drawing showing the case where the pads Pad1 of the nonvolatile semiconductor storage chip are arranged along both short sides SL1 and SL2 of the nonvolatile semiconductor storage chip Mem in a manner different from the nonvolatile semiconductor storage chip Mem shown in FIG. 11.

In the example, the controller chip M_Ctrl is disposed on the long side ML2 opposite to the long side ML1 of the nonvolatile semiconductor storage chip Mem on which the voltage supply interrupting circuit BlkIC is disposed.

With the configuration, as shown in FIG. 13, the pads Pad1 of the nonvolatile semiconductor storage chip and the pads Pad2 of the controller positioned on the short sides SL1 and SL2 can be disposed without overlapping each other.

### Other Placements of Voltage Supplying Unit BlkIC

FIG. 11 shows the case where the voltage supply interrupting unit BlkIC is disposed so as to be lined between the long side ML1 of the nonvolatile semiconductor storage chip Mem and the secure IC chip SecIC.

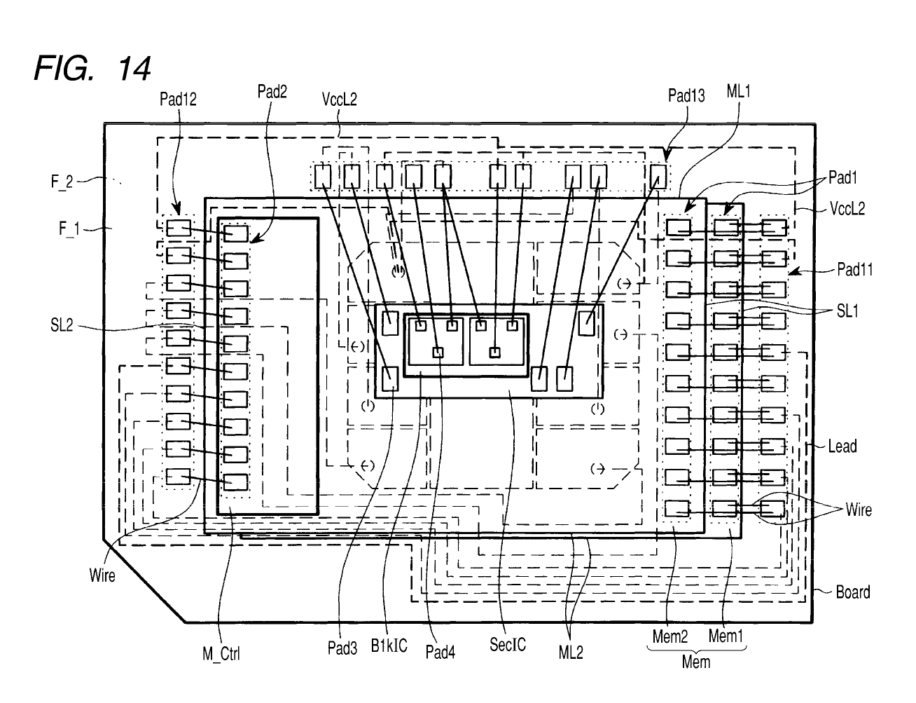

As another method, as shown in FIG. 14, the voltage supply interrupting unit BlkIC may be stacked on the secure IC chip SecIC so as not to cover the pads Pad3 of the secure IC chip.

With the configuration, for example, even when the shape of the card becomes small, particularly, even when the nonvolatile semiconductor storage chip Mem becomes small, the voltage supply interrupting unit BlkIC can be effectively disposed on the card or chip.

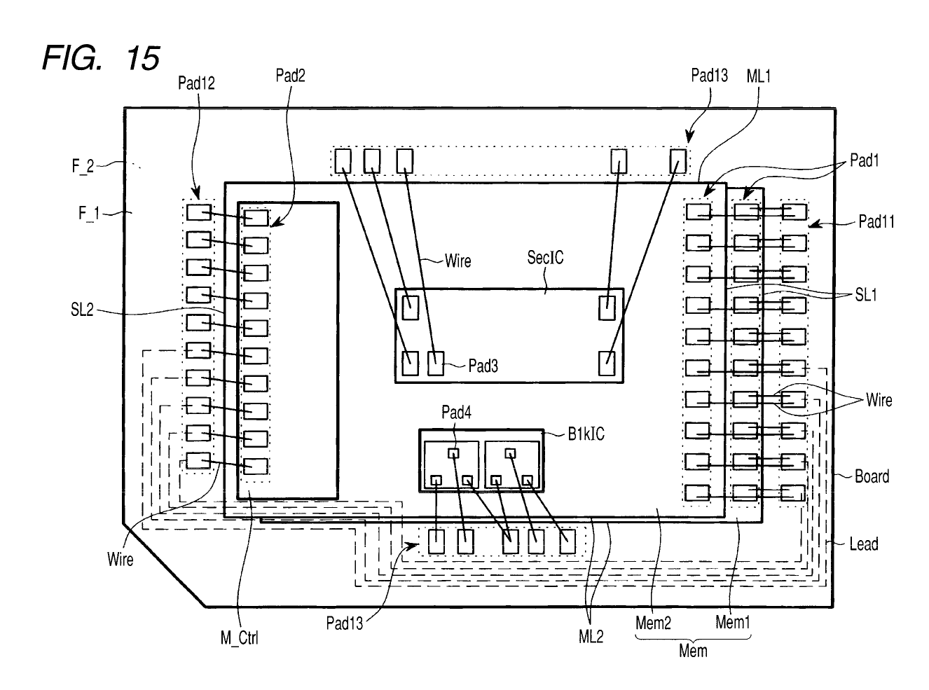

As another method, as shown in FIG. 15, the voltage supply interrupting unit BlkIC may be disposed close to the long side ML2 of the nonvolatile semiconductor storage chip Mem on the side opposite to the placement shown in FIG. 11. With the configuration, for example, in the case where the number of the pads Pad3 of the secure IC chip is increased to add a function of the secure IC chip SecIC, short circuit of the wire “Wire” can be prevented.

In the sixth embodiment, the mounting configuration has been described using the first embodiment as an example. The configuration can be also applied to the other embodiments.

### Effects of the Sixth Embodiment

As described above, by stacking a semiconductor chip having a smaller shape on the nonvolatile semiconductor storage chip Mem, the semiconductor chip can be also disposed also in the case where the shape of a card becomes small.

In the case of disposing the pads Pad1 to Pad4 of the semiconductor chips concentratedly along one side of the semiconductor chips, wire coupling between the pads Pad11 to Pad13 of the wiring board on which the semiconductor chips are mounted and the pads on the semiconductor chips is easy.

In the case of stacking a plurality of nonvolatile semiconductor storage chips Mem on the wiring board “Board”, when pads are concentratedly provided along one side of the semiconductor chips, stacking is easy.

Further, in the case of mounting the controller chip M_Ctrl on the nonvolatile semiconductor storage chips Mem, the controller chip M_Ctrl is disposed along a side different from the side along which the pads Pad1 of the nonvolatile semiconductor chip are disposed, in a position closer to the different side than to the side along which the pads Pad1 are disposed. It reduces the danger that the wires “Wire” coupling the pad Pad2 of the controller and the pads Pad11 to Pad13 of the wiring board come into contact with the wires “Wire” coupling the pad Pad1 of the nonvolatile semiconductor storage chip and the pads Pad11 to Pad13 of the wiring board, and coupling of the wires “Wire” is facilitated.

### Other Embodiments

The first to sixth embodiments have been described. The embodiments may be combined or the embodiments may be partly combined. The embodiments may be properly changed by combining others.

The present invention can be applied to, for example, the semiconductor industry necessary to configure an IC card having a plurality of card functions.

What is claimed is:

1. A semiconductor device comprising:
a power source terminal to which a first power source voltage and a second power source voltage higher than the first power source voltage are supplied;
a grounding terminal to which a grounding voltage is supplied;
a first power source line coupled to the power source terminal;
a logic semiconductor chip which is coupled to the first power source line and the grounding terminal, operates on any of the first power source voltage and the second power source voltage, and performs a logic process on input data;
a power supply interrupting semiconductor chip which is coupled to the first power source line and the grounding terminal, when the first power source voltage is supplied, outputs the voltage to a second power source line and, when the second power source voltage is supplied, stops supplying the voltage to the second power source line;
a nonvolatile semiconductor storage chip which is coupled to the second power source line and the grounding terminal and operates on supply of the voltage; and
a controller chip which is coupled to the second power source line and the grounding terminal, has a first terminal to which a signal is input and, on reception of the input signal, inputs/outputs data to/from the nonvolatile semiconductor storage chip.

2. A semiconductor device comprising:
a power source terminal to which a first power source voltage and a second power source voltage higher than the first power source voltage are supplied;
a grounding terminal to which a grounding voltage is supplied;
a first power source line coupled to the power source terminal;
a logic semiconductor chip which is coupled to the first power source line and the grounding terminal, operates on any of the first power source voltage and the second power source voltage, and performs a logic process on input data;
a power supply interrupting semiconductor chip which is coupled to the first power source line and the grounding terminal, when the first power source voltage is supplied, outputs the voltage to a second power source line and, when the second power source voltage is supplied, stops supplying the voltage to the second power source line;
a nonvolatile semiconductor storage chip which is coupled to the second power source line and the first power source line and operates on supply of the voltage; and
a controller chip which is coupled to the second power source line and the first power source line, has a first terminal to which a signal is input and, on reception of the input signal, inputs/outputs data from/to the nonvolatile semiconductor storage chip.

3. The semiconductor device according to claim 1,
wherein area of the nonvolatile semiconductor storage chip is larger than that of the logic semiconductor chip, the power supply interrupting semiconductor chip, and the controller chip, and
wherein the logic semiconductor chip, the power supply interrupting semiconductor chip, and the controller chip are mounted over the nonvolatile semiconductor storage chip.

4. The semiconductor device according to claim 3,
wherein the nonvolatile semiconductor storage chip has a rectangular shape,
wherein pads are arranged along one of four sides of the rectangular shape,
wherein a plurality of nonvolatile semiconductor storage chips are stacked so that the pads of the nonvolatile semiconductor chips are aligned in the nonvolatile semiconductor storage chips, and
wherein the controller chip is mounted over the uppermost nonvolatile semiconductor storage chip in the stacked chips along a side different from the side along which the pads of the nonvolatile semiconductor storage chip are arranged in a position closer to the different side.

5. A semiconductor device comprising:
a power source terminal to which a first power source voltage and a second power source voltage higher than the first power source voltage are supplied;
a grounding terminal to which a grounding voltage is supplied;
a first power source line coupled to the power source terminal;
a logic semiconductor chip which has a power supply interrupting circuit, when the first power source voltage is supplied, for outputting the voltage to a second power source line and, when the second power source voltage is supplied, stops supplying the voltage to the second power source line, wherein the logic semiconductor chip is coupled to the first power source line and the grounding terminal, operates on any of the first power source voltage and the second power source voltage, and performs a logic process on input data;
a nonvolatile semiconductor storage chip which is coupled to the second power source line and the grounding terminal and operates on supply of the voltage; and
a controller chip which is coupled to the second power source line and the grounding terminal, has a first terminal to which a signal is input and, on reception of the input signal, inputs/outputs data from/to the nonvolatile semiconductor storage chip.

6. A semiconductor device comprising:
a power source terminal to which a power source voltage is supplied;
a grounding terminal to which a grounding voltage is supplied;
a first power source line coupled to the power source terminal;
a first semiconductor chip which is coupled to the first power source line and the grounding terminal;
a power source voltage supply control circuit which is coupled to the first power source line and the grounding terminal and controls whether or not voltage is output from the first power source line to a second power source line in accordance with a signal input from the outside; and
a second semiconductor chip which is coupled to the second power source line and the grounding terminal and operates on reception of the voltage supplied.

7. The semiconductor device according to claim 6, further comprising a third semiconductor chip different from the first and second semiconductor chips and having the power source voltage supply control circuit,
wherein the signal input from the outside is supplied to the first semiconductor chip, and
wherein a signal responding to the signal input from the outside supplied from the first semiconductor chip is supplied to the third semiconductor chip, and the power source voltage supply control circuit controls a voltage output.

8. The semiconductor device according to claim 6, wherein the second semiconductor chip has a nonvolatile semiconductor storage chip capable of retaining data even when supply of the power source voltage stops.

9. The semiconductor device according to claim 6, wherein the second semiconductor chip has an internal step-down circuit for stepping down the power source voltage supplied from the outside and supplying the resultant voltage to the inside.

10. A semiconductor device comprising:
a first semiconductor chip which is coupled to a power source terminal to which a first power source voltage is supplied and a grounding terminal to which a grounding voltage is supplied, and outputs a control signal in accordance with an input signal;
a power supply interrupting semiconductor chip coupled to the power source terminal and the grounding terminal and supplying or stopping a second power source voltage to a power source line in accordance with output of the control signal;
a nonvolatile semiconductor storage chip coupled to the power source line and the grounding terminal, operates on receipt of the second power source voltage, and inputs/outputs data in response to a signal input from a first terminal;
a controller chip for controlling the nonvolatile semiconductor storage chip; and
a wiring board having a first surface over which the first semiconductor chip, the power supply interrupting semiconductor chip, the nonvolatile semiconductor storage chip, or the controller chip is arranged, and a second surface having an external terminal for inputting/outputting a signal from/to a second terminal provided for the first semiconductor chip and the first terminal of the controller chip,
wherein the wiring board, the first semiconductor chip, the power supply interrupting semiconductor chip, and the controller chip have pads to be coupled to each other via wires,
wherein the nonvolatile semiconductor storage chip has a rectangular shape and is provided over the wiring board,
wherein area of the first semiconductor chip is smaller than that of the nonvolatile semiconductor storage chip,
wherein the first semiconductor chip is arranged over the nonvolatile semiconductor storage chip,
wherein pads of the first semiconductor chip are provided along a first long side of the rectangular shape of the nonvolatile semiconductor storage chip and coupled to pads of the wiring board provided along the first long side via wires,
wherein area of the controller chip is smaller than that of the nonvolatile semiconductor storage chip,
wherein the controller chip is arranged over the nonvolatile semiconductor storage chip,
wherein pads of the controller chip are provided along a first short side or a second long side of the rectangular shape of the nonvolatile semiconductor storage chip and coupled to pads of the wiring board provided along the first short side or the second long side via wires,
wherein area of the power supply interrupting semiconductor chip is smaller than that of the nonvolatile semiconductor storage chip,
wherein the power supply interrupting semiconductor chip is arranged over the nonvolatile semiconductor storage chip, and
wherein pads of the power supply interrupting semiconductor chip are provided along the first long side of the rectangular shape of the nonvolatile semiconductor storage chip and coupled to pads over the wiring board provided along the first long side via wires.

11. The semiconductor device according to claim 10,
wherein the power supply interrupting semiconductor chip is provided between the pads of the wiring board provided along the first long side of the rectangular shape of the nonvolatile semiconductor storage chip and the first semiconductor chip,
wherein each of the first semiconductor chip and the power supply interrupting semiconductor chip has a rectangular shape, and
wherein one side of the rectangular shape of the first semiconductor chip facing the first long side of the rectangular shape of the nonvolatile semiconductor storage chip is longer than one side of the power supply interrupting semiconductor chip facing the first long side of the nonvolatile semiconductor storage chip.
